(19) United States
(12) Patent Application Publication
(10) Pub. No.: US 2010/0311396 A1
(43) Pub. Date: Dec. 9, 2010

(54) CALL CONTROL METHOD AND SYSTEM

(75) Inventors: Woo Tae KIM, Daegu (KR); Young Hae KIM, Gyeonggi-do (KR); Sang Hoon LEE, Daegu (KR); Tae Gyun LIM, Daegu (KR)

Correspondence Address: Cha & Reiter, LLC, 17 Arcadian Avenue, Suite 208, Paramus, NJ, 07652, US

(73) Assignee: SAMSUNG ELECTRONICS CO., LTD., Gyeonggi-Do (KR)

(21) Appl. No.: 12/796,895

(22) Filed: Jun. 9, 2010

(30) Foreign Application Priority Data
Jun. 9, 2009 (KR) 10-2009-0050875

(51) Int. Cl. H04M 3/42

(52) U.S. Cl. 455/414.1

(57) ABSTRACT

A method of controlling a call that can apply the service fee system according to user's selection. The method includes: alarming a reception of a first call request message in case a second terminal receives the first call request message from a first terminal; generating a call rejection message for the first call request message by the second terminal; transmitting by the second terminal the generated call rejection message to the first transmitting terminal; and generating a second call request message and transmitting by the second terminal the generated second call request message to the first terminal.

### CLAIM OF PRIORITY

Applicant claims the benefit of priority from Korean Patent Application No. 10-2009-0050875 filed Jun. 9, 2009, the contents of which are hereby incorporated by reference in its entirety.

### BACKGROUND OF THE INVENTION

1. Field of the Invention

The present invention relates to a call control system and method for a portable terminal. More particularly, the present invention relates to a call control system and method for flexibly supporting a service fee system application.

2. Description of the Related Art

Many people use portable terminals because of various user functions such as a mobile communication function, a game function and a scheduling function can all be provided while maintaining portability.

However, since such portable terminals in its most basic form must be truly portable, manufacturers should ensure that portable terminals are made to be small in size, maximize energy from the battery, and should include various designs in order to satisfy consumers' various desires. In addition, recently portable terminals have been designed to maximize the limited space provided in order to accommodate all the various functions.

In addition, as the portable terminal uses a mobile communication function, so that the mobile service fees are generally more expensive than the fixed-line service fees. Hence, the service providers, which support mobile communication, try to attract more customers by giving them more benefits by diversifying the service rate packaging.

However, the existing mobile communication rate packing has been provided by the service providers in a manner that it is hard to satisfy the user's needs that require real-time selections and operation.

### SUMMARY OF THE INVENTION

The present invention provides a call control method and a call control system supporting the method, which can apply the service fee system according to user's selection.

In accordance with an exemplary aspect of the present invention, a method of controlling a call includes: alarming a reception of a first call request message when a receiving terminal receives the first call request message from a transmitting terminal by a receiving terminal; generating a call rejection message for the first call request message by the receiving terminal; transmitting the generated call rejection message to the transmitting terminal by the receiving terminal; and generating a second call request message and transmitting the generated second call request message to the transmitting terminal by the receiving terminal.

In accordance with another exemplary aspect of the present invention, a system for controlling a call includes: a transmitting terminal which transmits a first call request message; and a receiving terminal which generates a call rejection message and a second call request message according to an input signal from an input unit, and transmits the generated call rejection message and the generated second call request message to the transmitting terminal when receiving the first call request message.

### BRIEF DESCRIPTION OF THE DRAWINGS

The above and other exemplary aspects, features, and advantages of certain exemplary embodiments of the present invention will become more apparent to a person of ordinary skill in the art from the following description taken in conjunction with the accompanying drawings, in which:

FIG. 1 schematically illustrates a configuration of a call control system according to an exemplary embodiment of the present invention;

FIG. 2 is a schematic block diagram illustrating an exemplary configuration of the portable terminal of FIG. 1;

FIG. 3 illustrates a signal flow between systems for a call connection according to an exemplary embodiment of the present invention;

FIG. 4 is a flowchart illustrating an exemplary operation of a process of a transmitting terminal according to the present invention; and

FIG. 5 is a flowchart illustrating an exemplary operation of a process of a receiving terminal according to the present invention.

### DETAILED DESCRIPTION

Exemplary embodiments of the present invention are described with reference to the accompanying drawings in detail. The same reference numbers are used throughout the drawings to refer to the same or like parts. Detailed descriptions of well-known functions and structures incorporated herein may be omitted to avoid obscuring appreciation of the subject matter of the present invention by a person of ordinary skill in the art.

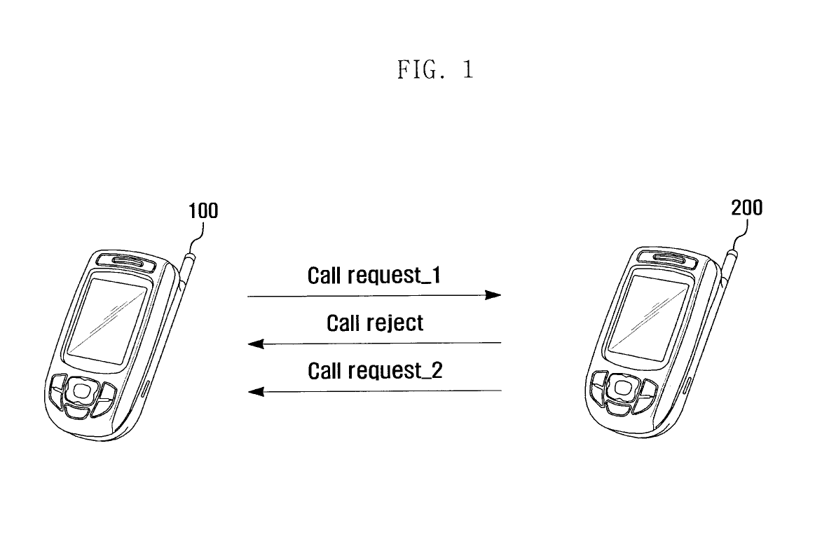

FIG. 1 schematically illustrates a configuration of a call control system according to an exemplary embodiment of the present invention.

Referring now to FIG. 1, a system for a call connection according to an exemplary embodiment of the present invention comprises a first portable terminal 100 and a second portable terminal 200. Practically, the system for a call connection may further include a configuration of a mobile communication system which manages reception and transmission of signals between the first portable terminal 100 and the second portable terminal 200.

Hereinafter, it will be illustrated in this example that the first portable terminal 100 is a transmitting terminal as an initial call request terminal and the second portable terminal 200 is a receiving terminal which can select call fee payment as the first portable terminal 100 requests a call. However, the present invention is not limited to this arrangement. For example, the second portable terminal 200 can be used as a transmitting terminal, and the first portable 100 can also be used as a receiving terminal.

In the case where the first portable terminal 100 included in the call control system of the present invention inputs the phone number of the second portable terminal 200 and performs a call connection request based on the inputted phone number, a first call request message (Call request_1) is transmitted in the direction from the first portable terminal 100 to the second portable terminal 200. Further, if the first call request message (Call request_1) is received from the first portable terminal 100, the second portable terminal 200 can output an alarm, which informs of reception of a corresponding message, according to conditions which are set in the terminal, such as a bell sound, vibration and a silent alarm. At this time, the user, who holds the second portable terminal 200, seeks to have a phone conversation with the first portable terminal 100 by applying the user's own service fee system and a preset input signal can be generated. The preset input signal can be, for example, a signal according to activation of an input key which is set for the service fee system selection, a touch event corresponding to the signal in the case where the second portable terminal 200 supports a touch screen, or a sensor signal corresponding to the input signal in the case where the second portable terminal 200 supports terminal operation based on an operating sensor.

According to an exemplary aspect of the present invention, when the user of the second portable terminal 200 tries to have a call connection by applying his service fee system, and generates an input signal corresponding to the service fee system, a call rejection message (Call reject) for the first call request message (Call request_1) can be transmitted in the direction from the second portable terminal 200 to the first portable terminal 100. Thereafter, the second portable terminal 200 can transmit the second call request message (Call request_2) based on the phone number of the first portable terminal 100 right after transmitting the call rejection message (Call reject) to the first portable terminal 100.

In this process, the second portable terminal 200 supports automatically transmitting the call rejection message (Call reject) and the second call request message (Call request_2) to the first portable terminal 100 if a preset input signal is generated to apply its own service fee system. Hence, the user of the second portable terminal 200 can simply select whether to apply the service fee system of the first portable terminal 100 or to apply its own service fee system according to generation of a certain input signal for a call connection with the first portable terminal 100.

Further, after transmitting the first call request message (Call request_1) to the second portable terminal 200, the first portable terminal 100 can automatically form a call channel without generating an input signal for a separate call connection if the call rejection message (Call reject) and the second call request message (Call request_2) are sequentially received, or if the second call request message (Call request_2) is received within a preset time after receiving the call rejection message (Call reject). Therefore, the first portable terminal 100 can be provided a call connection service in which the service fee system of the second portable terminal 200 is applied only by an operation for transmitting the initial first call request message (Call request_1) without an additional operation for a call connection with the second portable terminal 200.

In addition, the first portable terminal 100 temporarily stores phone numbers of the second portable terminal 200 included in the first call request message (Call request_1) in a storage unit, and after receiving a call rejection message (Call reject), if the first portable terminal 100 receives the second call request message (Call request_2) containing the same phone number as the temporarily-stored phone number, the first portable terminal 100 can be controlled so as to automatically form a call channel with the second portable terminal 200 that transmitted the second call request message (Call request_2).

Such a call control system according to the present invention can be useful in the case where the user of the first portable terminal 100 does not desire being burdened with paying the service fee, or the user of the second portable terminal 200 finds it desirous to apply his own service fee system when talking to the user of the first portable terminal 100. Moreover, the call control system advantageously permits the user of the second portable terminal 200, who is registered for a certain service fee type, for example, a type in which an inexpensive or free service fee is applied for a preset amount of time, to apply his own service fee system in place of a relatively more expensive service fee type of the user of the first portable terminal 200.

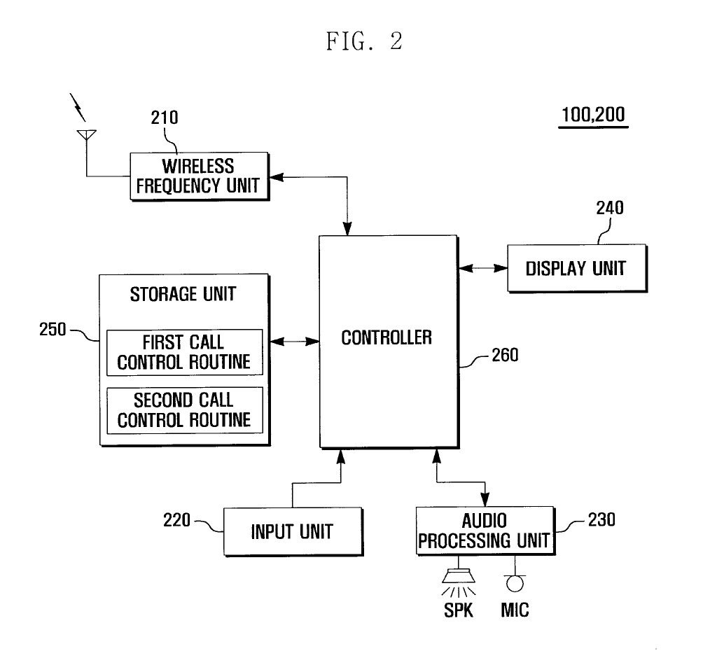

Hereinafter, a configuration of a terminal for supporting a service fee system application between the first portable terminal 100 and the second portable terminal 200 according to an exemplary aspect of the present invention will be explained in more detail with reference to FIG. 2. As stated above, the roles of the first portable terminal 100 and the second portable terminal 200 as described in the example throughout the disclosure can be reversed. In addition, by producing a terminal having both transmission and reception functions at the time of producing the terminal, the configuration of a portable terminal described herein after can be a respective configuration for each of the first portable terminal 100 and the second portable terminal 200.

FIG. 2 is a schematic block diagram illustrating an example of a respective configuration for a first portable terminal or a second portable terminal according to an exemplary embodiment of the present invention.

Referring now to FIG. 2, the first portable terminal 100 and/or the second portable terminal 200 of the present invention can preferably include a wireless frequency unit 210, an input unit 220, an audio processing unit 230, a display unit 240, a storage unit 250 and a controller 260.

A first portable terminal 100 and/or a second portable terminal 200 having such a configuration as shown in FIG. 2 permits input of phone numbers of other portable terminals using the input unit 220, and can transmit the first call request message to the another portable terminal based on a phone number inputted according to an input signal for an additionally inputted call connection request. The portable terminal that received the first call request message may transmit a call rejection message in response to the first call request message received according to generation of a certain input signal, and transmit a second call request message for a new call connection to another portable terminal. In addition, the portable terminal that receives the call rejection message and the second call request message can also perform an automatic call connection according to the terminal setting.

Hereinafter, a call connection process according to an exemplary embodiment of the present invention will be explained in more detail in terms of the role and the function of each configuration. Hereinafter, while a person of skill in the art appreciates that the roles of the first terminal and second terminal can be reversed, the first portable terminal 100 comprises a transmitting terminal that transmits the first call request message, and the second portable terminal 200 comprises a receiving terminal that transmits a call rejection message and a second call request message.

The wireless frequency unit 210 provides transmission and reception of a signal related with mobile phone communication, a short message service (SMS), a multimedia message service (MMS) and a data communication under control of the controller 260. In addition, the wireless frequency unit 210 converts voice/sound data and control data into wireless signals and transmits the wireless signals, and receives wireless signals, converts the received wireless signals into voice/sound data and control data or the like and outputs the voice/sound data and control data. To this end, the wireless frequency unit 210 can include a transceiver which up-converts and amplifies the frequency of a transmitted signal, and low-noise-amplifies a received signal and down-converts the frequency.

More particularly, the wireless frequency unit 210 of the present invention transmits the first call request message, or the second call request message, to a portable terminal including phone numbers received from the input unit 220. That is, the wireless frequency unit 210 included in the first portable terminal 100 transmits the first call request message to the second portable terminal 200 according to the input signal of the input unit 220, and the wireless frequency unit 210 included in the second portable terminal 200 transmits the call rejection message and the second call request message to the first portable terminal 100 according to the input signal of the input unit 220. In addition, if the wireless frequency unit 210 of the first portable terminal 100 receives the call rejection message and the second call request message, a message for a call connection with the second portable terminal 200 can be automatically transmitted to the mobile communication system under control of the controller 260. Thus, the mobile communication system can transmit the first call request message (Call request_1) of the first portable terminal 100 to the second portable terminal 200, and can transmit the call rejection message and the second call request message of the second portable terminal 200 to the first portable terminal 100. If the first portable terminal 100 transmits a confirmation message for the second call request message, the mobile communication system can be controlled to form a call channel between the first portable terminal 100 and the second portable terminal 200, and can also be controlled to form a call channel between the first portable terminal 100 and the second portable terminal 200 without receiving a confirmation message regarding the call channel from the first portable terminal 100.

With continued reference to FIG. 2, the input unit 220 preferably includes a plurality of input keys and function keys for receiving the input of numbers or letter information and setting various functions. The function keys can include a direction key or keys, a side key and a shortcut key so that a certain function can be performed. In addition, the input unit 220 generates a key signal related with the user setting and function control of the portable terminal to the controller 260. Such an input unit 220 can be implemented as a QWERTY keypad, 3*4 keypad and a 4*3 keypad, DVORAK keypad, etc., including a plurality of keys. The input unit 220 transmits input signals generated by the actuation of a certain key of the keypad to the controller 260, and, at this time, various input signals can be generated according to the currently activated application program. In addition, the input unit may include a hot key for call fee system selection. The hot key can generate a certain input signal and transmit the generated input signal to the controller 260 if the hot key is activated by user in the state where a call request was transmitted from the transmitting portable terminal. In the state where a first call request message is received from the transmitting portable terminal, if an input signal corresponding to the hot key is received, the controller 260 preferably controls generation and transmission of a message for applying the call fee system based on the received input signal. The message for applying the call fee system based on the received input signal will be explained in more detail in the description of the controller 260. Further, the hot key can be separately manufactured and implemented in a portable terminal, but can be allocated to a certain number key, a special character key and a volume key or the like.

The audio processing unit 230 preferably includes a transducer such as speaker (SPK) for playing audio data, which is received and transmitted when calling, and a microphone (MIC) for collecting user's voice and other audio signals when calling. In addition, the audio processing unit 230 can output a preset bell sound or vibration according to reception of a first call request message or a second call request message.

The display unit 240 displays information inputted by user or information provided to user as well as various menus. That is, the display unit 240 can provide various screens according to the use of the portable terminal 100 such as, for example, a standby screen, a menu screen, a message generation screen and a calling screen. In particular, when receiving the first call request message or the second call request message, the display unit 240 can output a preset screen including phone numbers of a terminal that transmitted the call request message. In the case where information on a terminal that received the first call request message or the second call request message is stored in the phone book, the portable terminal can control to read the information stored in the phone book and output the read information in the display unit. In the aforementioned process, in the case where image information such as pictures is stored together in the phone book, the image information can also be output to the display unit 240. In addition, in the case where an input signal for service fee system selection is generated, the display unit 240 of the present invention can output a pop-up window for confirming the generation, for example, a pop-up window including buttons for service fee system selection. In addition, the pop-up window can be automatically output in the display unit 240 at the time point when the first call request message transmitted by the transmitting terminal is received.

Therefore, if an input signal for activating a confirmation button for service fee system selection is input in a pop-up window without an input of a hot key, the second portable terminal can be controlled to perform a process for applying a corresponding service fee system.

With continued reference to FIG. 2, the display unit 240 can be formed as a liquid crystal display (LCD), an organic light emitted diode (OLED) or the like. Virtually any thin film technology displays screen can be used. In the case where the display unit is operated as a touch screen by adding a touch sensor on the front side or at least one side, the display unit 240 can also serve as an input unit. At this time, the display unit 240 can output an image including various menu maps and key maps for a function as an input unit, and if user touches the display unit 240 in order to indicate a certain portion from the image, the touch sensor senses the touch, and transmits the corresponding position information to the controller 260. Then the controller 260 can control to map a touch event generated according to the touch with the outputted image, and to activate a certain function allocated to the image. Therefore, the hot key explained in the input unit 220 can be displayed in the display unit 240 in the form of an image. Such a hot key image can be outputted to the display unit 240 from the time point of receiving the first call request message transmitted by the transmitting terminal to the time point when a call connection is made. If the hot key image is displayed in the display unit 240, the user of the portable terminal can generate an input signal for service fee system selection by touching a corresponding image. A person of ordinary skill in the art should understand and appreciate that the units shown in FIG. 2 can be physically integrated into fewer units and are separated in the drawings for purposes of explaining the different functionalities of each unit.

The storage unit 250 can store an application program necessary for operating a function according to an exemplary embodiment of the present invention. For example application programs for playing stored various files, and a key map or a menu map for operating a touch screen in case the display unit 240 is implemented as a touch screen can be stored thereon. The key map or the menu map can be made in various forms. In other words, the key map may comprise a keyboard map, a 3*4 key map, a QWERTY map, a DVORAK key map, or a control key map for controlling operation of a currently activated application program. In addition, the menu map can control operation of a currently activated application program, or a menu map having various menus provided by the portable terminal as items. Particularly, the storage unit 250 can store an application program for service fee system selection. Such a storage unit 250 can preferably include a program area and a data area.

The program area can store an operating system (OS) for the booting of a portable terminal 100 and operation of each configuration, and an application program for playing various files, such as an application program for supporting a calling function according to whether the function of the portable terminal 100 is supported, a web browser for connecting to an Internet server, an MP3 application program for playing other music sources, an image output program for playing pictures, and an application program for playing video. More particularly, the program area of the present invention can store an application program for service fee system selection. The application program for the service fee system selection can be loaded to the controller 260 in the process when the terminal is booted or at the time point when the first call request message or the second call request message is received. The application program for the service fee system selection can include a first call control routine including control commands for service fee system selection as a receiving terminal and a second call control routine including control commands for call connection as a transmitting terminal. The first call control routine can include commands that display a pop-up window in which it is asked whether a service fee system will be selected when the first call request message transmitted by the transmitting terminal is received, commands that generate and transmit a call rejection message for the currently received first call request message, commands that extract opponent's phone number from the currently received first call request message, and commands that generate and transmit the second call request message based on the extracted phone numbers. In addition, the second call control routine can include commands for automatic call connection when a second call request message is received after a call rejection message is received from the receiving terminal. In other words, the second call control routine can include commands that control automatically connecting a call based on the second call request message which is received within a preset time after the call rejection message is received, or commands that control automatic connection of a call when the second call request message is received wherein the second call request message includes the same phone numbers as the phone numbers included in the first call request message transmitted to the receiving terminal.

The data area is a part of the storage area where data is stored as the portable terminal 100 is used, and can store various contents. In addition, in case the display unit is implemented as a touch screen, the data area can store a user input which is provided through a touch screen. Particularly, the data area of the present invention can temporarily store an image corresponding to a pop-up window for a service fee system selection, opponent's phone number included in the first call request message received from the transmitting terminal, and the phone number of the transmitting terminal included in the first call request message.

The controller 260 controls the supply of power to each configuration of the portable terminal to perform the initialization process, and controls the flow of each signal so that service fee system selection function of the present invention can be supported for each configuration when the initialization process is completed. The role of such a controller 260 will be explained on behalf of the transmitting terminal and the receiving terminal, respectively.

First, if a phone number provided from the input unit 220 and an input signal for requesting a call connection are transmitted, the controller of the transmitting terminal controls transmission of the first call request message including a corresponding phone number to the receiving terminal through the mobile communication system. In addition, the controller of the transmitting terminal can activate/output an alarm if a call rejection message and a second call request message are received from the receiving terminal. That is, the controller of the transmitting terminal can activate/output an alarm through the display unit or the audio processing unit that the second call request message was received, if the second call request message is received from the receiving terminal, and can thus alarm the user in a preset form such as vibration and a silent lamp. To this end, the transmitting terminal can further include a vibration unit and a lamp. Thereafter, if the user generates an input signal for a call connection, the controller of the transmitting terminal controls performance of a call connection with the receiving terminal. In addition, the controller of the transmitting terminal can control a call connection to be made automatically without reception of a separate input signal in case a call rejection message and a second call request message are received from the receiving terminal after transmitting the first call request message to the receiving terminal. Here, if the call rejection message is received, the controller of the transmitting terminal can cause cancellation of the call connection standby state and transfer to the standby state where the second call request message can be received after the first call request message is transmitted.

In the case where the first call request message is received from the transmitting terminal, the controller of the receiving terminal controls to output a pop-up window for service fee system selection, and checks whether a button is activated by which the service fee is paid by the receiving terminal. Alternatively, when the first call request message is received, the controller of the receiving terminal may not output a separate pop-up window, and can activate/output an alarm through the display unit or the audio processing unit, and can check whether an input signal corresponding to a preset hot key is received. In addition, if an input signal is generated by which the receiving terminal pays the service fee, the controller of the receiving terminal can generate a call rejection message for the first call request message, and transmit the generated call rejection message to the transmitting terminal through the mobile communication system. In addition, the controller of the receiving terminal controls extraction of the phone number of the transmitting terminal from the first call request message, generates a second call request message based on the extracted phone number, and then transmits the generated second call request message to the transmitting terminal through the mobile communication system. Thereafter, the controller of the receiving terminal can perform a call connection with the transmitting terminal according to the call connection control of the mobile communication system.

As explained herein above, a call control system and a portable terminal that constitutes the call control system according to an exemplary embodiment of the present invention can perform a call connection so that the second portable terminal 20 can pay the service fee according to the selection of user of the second portable terminal 200 in the case where the first portable terminal 100 initiates a call request.

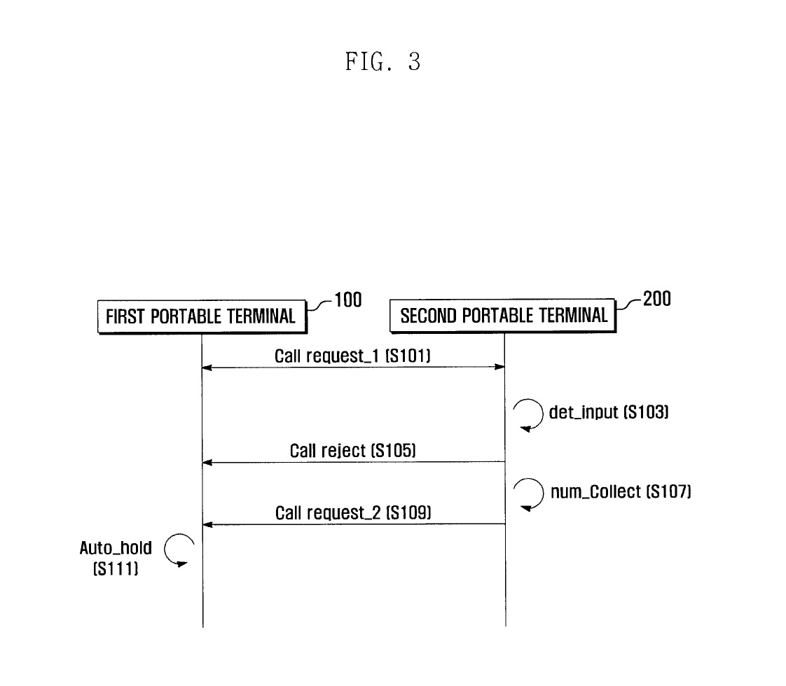

FIG. 3 illustrates transmission and reception of signals which are necessary for supporting a service fee selection function according to an exemplary embodiment of the present invention.

Referring now to FIG. 3 at (S101), a call control system according to an exemplary embodiment of the present invention controls the first portable terminal 100 to generate a phone number input signal generation of user and transmit the first call request message (Call request_1) to the second portable terminal 200 according to the generation of the input signal for a call connection. Then, if the first call request message (Call request_1) is received from the first portable terminal 100, the second portable terminal 200 provides a corresponding alarm output. For example, the second portable terminal 200 can output an image informing the first portable terminal 100 requested about a call, or can sound a preset bell, vibrate or light a lamp. To this end, the second portable terminal 200 can further include a vibration unit for vibration and a lamp for lighting illumination. Further, at (S103) the second portable terminal 200 can receive a preset input signal (det_input) which is generated in order to apply its own service fee system when a call is connected with the first portable terminal 100. To this end, the second portable terminal 200 can output a pop-up window for applying the service fee system or can set generation of a key input signal for applying the service fee system to a certain key when the first call request message (Call request_1) is received.

Furthermore, if an input signal (det_input) for service fee selection is transmitted, then at (S105) the second portable terminal 200 generates a call rejection message (Call reject) based on the transmitted input signal, and transmits the message to the first portable terminal 100.

In addition, the second portable terminal 200 extracts the phone number of the first portable terminal 100 from the first call request message (Call request_1) (S107), generates a second call request message (Call request_2) based on the extracted phone number, and at (S109) transmits the generated second call request message to the first portable terminal 100.

Further, if the second call request message (Call request_2) is received from the second portable terminal 200, at (S111) the first portable terminal 100 can be controlled to make a call connection automatically according to the received second call request message (Call request_2). In other words, if the second call request message (Call request_2) is received, the first portable terminal 100 outputs an alarm to the user, and can perform an automatic connection (Auto Hold) process, so that a call channel is automatically formed with the second portable terminal without generation of a separate input signal. In the process, the second portable terminal 200 can output the phone number of the second portable terminal along with a certain image in the display unit, or can output a preset bell sound, vibration and/or a silent lamp according to the terminal setting in a manner that the second portable terminal 200 sounds an alarm for the first call request message (Call request_1). Here, the first portable terminal 100 can selectively activate the automatic connection process according to the mode selection. That is, in case user does not select automatic connection, the first portable terminal 100 can be controlled to output alarm reception of the second call request message (Call request_2), and in case an input signal for a call connection is generated, the first portable terminal 100 can be controlled to perform a call connection.

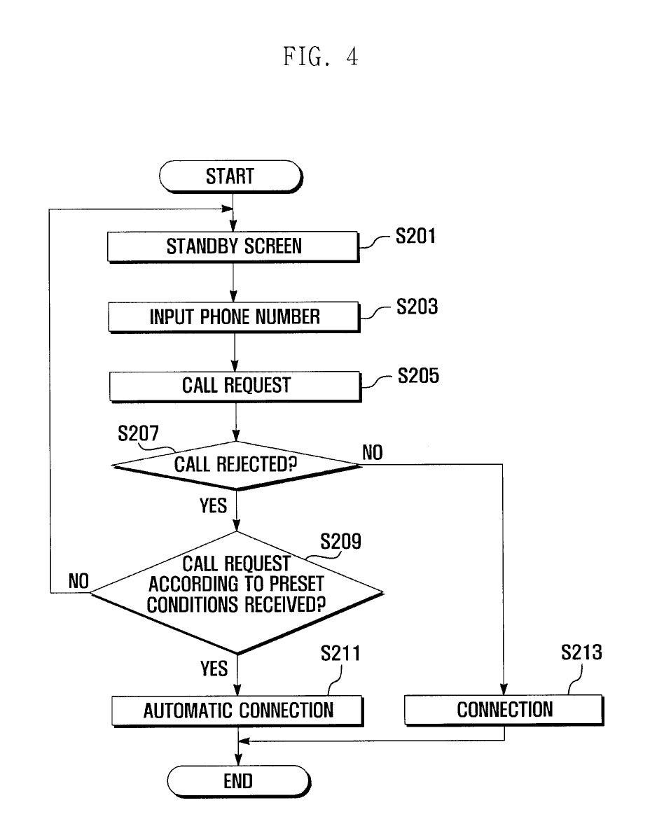

FIG. 4 is a flowchart illustrating a detailed operation process of a first portable terminal that is a transmitting terminal, according to an exemplary embodiment of the present invention.

Referring now to FIG. 4, if power is supplied, the first portable terminal of the present invention can be controlled to complete booting of a terminal and at (S201) to output a preset standby screen. Practically, the output of a standby screen can be performed according to user's request in the slip state.

Next, at step 203, if an input unit or a touch screen prepared in the first portable terminal is supported, the user can input the phone number of opponent's portable terminal from which user desires to make a call connection using a touch screen. Here, in the case that the phone number of an another opponent's portable terminal is stored in the phone book, the first portable terminal can input the phone number through a phone book search or the like.

In addition, at (S205) after the phone number is inputted, if a call key for a call connection is activated, the first portable terminal performs a call request based on the inputted phone number from (S203). That is, the first portable terminal can generate a first call request message including the inputted phone number, and transmits the generated first call request message to the second portable terminal having the corresponding phone number through the mobile communication system.

Thereafter, at (S207), the first portable terminal can check whether a call rejection message for rejecting a call from the second portable terminal having a corresponding phone number is received. If the first portable terminal receives the call rejection message from the second portable terminal at step 207, at (S209) it is checked whether a call request according to preset conditions is received. That is, after receiving the call rejection message from the second portable terminal at step 209, the first portable terminal can check whether a second call request message is received within a preset time. In case a separate call request is not received at step 209, the first portable terminal returns to steps before step 201 and repeats the following process, or if there is no additional input, step 201 may be maintained.

Further, if a second call request message according to preset conditions is received at step 209, then an (S211) an automatic connection with the second portable terminal can be made without transmission of a separate user input signal. In this process, as stated above, in case a separate input signal is generated according to user's setting, the process can be selectively performed according to the mode selection.

Furthermore, if the first portable terminal does not receive a call rejection message, but receives a response message for a call connection at step 207, then at (S213) the first portable terminal forms a call channel with the second portable terminal and has a phone conversation. At this time, the first portable terminal can apply its own service fee system.

In the above description, the first portable terminal can output a screen according to the transmission of the first call request message, output a screen according to the reception of a call rejection message, output a screen according to the reception of a second call request message, and output a screen according to a call connection at step 213.

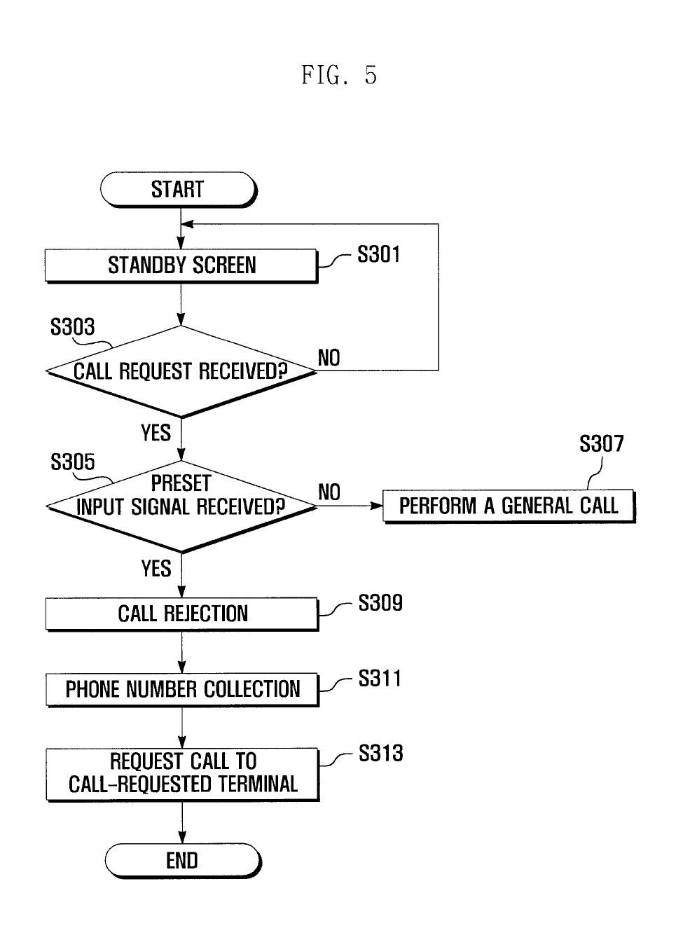

FIG. 5 illustrates an exemplary operation process according to a service fee system selection function of a second portable terminal, that is, a receiving terminal, according to an exemplary embodiment of the present invention.

Referring now to FIG. 5, at (S301) if power is supplied according to a user's control, the second portable terminal of the present invention can initialize configuration of each terminal, and output a preset screen in the display unit. Thereafter, at (S303), the second portable terminal checks whether a call request is received, and, if a separate call request was not received, the second portable terminal can return to the step prior to step 301 and perform the process of outputting a standby screen, or support various functions of the portable terminal according to the input signal received from the input unit.

Furthermore, in case a call request is received at step 303, that is, a first call request message is received from another portable terminal, then at (S305) the second portable terminal checks whether or not a preset input signal is received. Here, the preset input signal can be an input signal for allowing the second portable terminal user to pay the service fee for the call request received. To this end, the second portable terminal can set a function for the service fee system selection to a certain key, or display a pop-up window or a certain image in the display unit and support the user so that the user can select the service fee system.

In case an input signal for applying one's own service fee system is not received at step 305, that is, a call key for a general call is pushed, then at (S307) the second portable terminal can perform a general call. Here, a general call may mean a call in which a terminal that transmitted a call request message, pays the service fee.

Furthermore, a preset input signal for making the second portable terminal, a receiving terminal, pay the service fee is inputted from the input unit or the touch screen at step 305, then at (S309) the second portable terminal can perform a process for a call rejection. To this end, the second portable terminal cancels an alarm according to reception of the first call request message, generates a call rejection message, and transmits the call rejection message to the first portable terminal that transmitted the first call request message.

In addition, at (S311) the second portable terminal controls collecting another portable terminal's phone number from the first call request message, and at (S313) requests a call to the first portable terminal which requested a call. That is, the second portable terminal can transmit the second call request message to the first portable terminal through the mobile communication system. Thereafter, if the first portable terminal accepts a call, a call channel with the first portable terminal is formed, and a phone conversion is performed.

As explained above, a call control method according to an exemplary embodiment of the present invention allows a receiving terminal to pay the service fee for an opened call channel according to selection of the receiving terminal. Therefore, various service fee systems can be applied by allowing a receiving terminal to pay the service fee depending on the situation. In addition, since a procedure for paying the service fee is performed by one key input, the receiving terminal can overcome an inconvenient procedure for a call connection. In addition, on the part of the transmitting terminal, only a job for the initial call connection with the receiving terminal needs to be performed, and a call connection with the receiving terminal is automatically made, so that a call channel paid by the receiving terminal according to selection of the receiving terminal can be conveniently used.

According to a call control method and to a call control system supporting the method according to an exemplary embodiment of the present invention, portable terminal user can specify a service fee system according to his real-time selection.

The above-described methods according to the present invention can be realized in hardware or as software or computer code that can be stored in a machine readable recording medium such as a CD ROM, a RAM, thumbnail drive, a floppy disk, a flash storage, a hard disk, or a magneto-optical disk or downloaded over a network and stored as a non-transitory data on one of the aforementioned mediums, so that the methods described herein can be executed by such software using a general purpose computer, or a special processor or in programmable or dedicated hardware, such as an ASIC or FPGA. As would be understood in the art, the computer, the processor or the programmable hardware include memory components, e.g., RAM, ROM, Flash, etc. that may store or receive software or computer code that when accessed and executed by the computer, processor or hardware implement the processing methods described herein. In addition, it would be recognized that when a general purpose computer accesses code for implementing the processing shown herein, the execution of the code transforms the general purpose computer into a special purpose computer for executing the processing shown herein.

Although exemplary embodiments of the present invention have been described in detail hereinabove, it should be clearly understood that many variations and modifications of the basic inventive concepts herein taught which may appear to those skilled in the present art will still fall within the spirit and scope of the present invention, as defined in the appended claims.

What is claimed is:

1. A method of controlling a call, the method comprising:
alarming a reception of a first call request message in response to a second terminal receiving the first call request message transmitted from a first terminal;
generating by the second terminal a call rejection message in response to the first call request message;
transmitting by the second terminal the generated call rejection message to the first terminal; and
generating by the second terminal a second call request message and transmitting the generated second call request message to the first terminal.

2. The method of claim 1, wherein prior to the second terminal transmitting the generated call rejection message to the first terminal, the method further including:
receiving an input signal from an input key which is set so that the second terminal selects application of a service fee payment by the second terminal.

3. The method of claim 1, further comprising:
outputting a pop-up window or an image through which the second terminal can select application of a service fee payment of the second terminal; and
receiving by the second terminal an input signal for selecting the service fee payment through the pop-up window or the imagel.

4. The method of claim 2, further comprising:
stopping the alarming of reception of the first call request message when the second terminal receives the input signal.

5. The method of claim 1, further comprising:
extracting by the second terminal a phone number of the first terminal from the first call request message and generating the second call request message including the phone number of the first terminal.

6. The method of claim 1, further comprising:
receiving by the first terminal the call rejection message and the second call request message from the second terminal;
receiving by the first terminal a call key input signal that requests a call connection to the second call request message from the input unit; and
forming by the first terminal a call channel with the second terminal according to the call key input signal.

7. The method of claim 1, further comprising:
receiving by the first terminal the call rejection message and the second call request message from the second terminal; and
automatically connecting by the first terminal a call with the second terminal when the second call request message is received by the first terminal.

8. The method of claim 1, further comprising:
temporarily storing by the first terminal a phone number of the second terminal that transmitted the first call request message;
receiving by the first terminal the call rejection message and the second call request message from the second terminal; and
forming by the first terminal a call channel with the second terminal automatically when receiving the second call request message including the same phone number as the temporarily stored phone number of the second terminal.

9. The method of claim 1, further comprising:
receiving by the first terminal the call rejection message from the second terminal; and
forming by the first terminal a call channel with the second terminal automatically when receiving the second call request message within a preset time after receiving the call rejection message.

10. The method according to claim 1, wherein the second terminal pays a service fee according to selection of a user of the second terminal when the first portable terminal initiates a call request.

11. A system for controlling a call, the system comprising:
a first terminal that transmits a first call request message; and
a second terminal that generates a call rejection message and a second call request message according to an input signal from an input unit, and transmits the generated call rejection message and the generated second call request message to the first terminal when receiving the first call request message.

12. The system of claim 11, the second terminal further comprises at least one of:
an input unit which generates an input signal which is set to select a particular service fee payment;
a display unit which outputs a pop-up window or an image through which the second terminal can select the particular service fee payment; and
a touch screen that is arranged in the display unit, and generates an input signal according to the pop-up window or image touch.

13. The system of claim 12, wherein the second terminal comprises at least one of:
a display unit that outputs a screen set as an alarm in response to a reception of the first call request message;
an audio processing unit that outputs a sound set as an alarm in response to a reception of the first call request message;
a vibration unit that outputs a vibration set as an alarm in response to a reception of the first call request message; and
a lamp that outputs light set as an alarm in response to a reception of the first call request message.

14. The system of claim 13, wherein the second terminal stops the alarm to the reception of the first call request message when receiving the input signal from the input unit or the touch screen.

15. The system of claim 11, wherein the second terminal extracts a phone number of the first terminal from the first call request message and generates the second call request message.

16. The system of claim 11, wherein the first terminal forms a call channel with the second terminal according to the input of a call key when receiving the call rejection message and the second call request message from the second terminal.

17. The system of claim 11, wherein the first terminal makes a call connection with the second terminal automatically when the first terminal receives the call rejection message and the second call request message from the second terminal.

18. The system of claim 11, wherein the first terminal includes a storage unit which stores the phone number of the second terminal, and forms a call channel with the second terminal automatically when receiving the second call request message including a same phone number as a phone number of the second terminal.

19. The system of claim 11, wherein the first terminal forms a call channel with the second terminal automatically when receiving the second call request message within a preset time after receiving the call rejection message.

20. The system of claim 11, wherein the second terminal pays a service fee according to selection of a user of the second terminal when the first portable terminal initiates a call request.
